(19) United States
(12) Patent Application Publication
(10) Pub. No.: US 2005/0260393 A1
(43) Pub. Date: Nov. 24, 2005

(54) Substrate capable of preventing from warping and having protective layers to prevent from scrubbing

(76) Inventors: Tsung-Neng Liao, Taichung County (TW); Francis Chung Hwa Pan, Taichung Hisen (TW); John Chungteh Pan, Taichung City (TW); Chun-Chi Lee, Taipei City (TW)

Correspondence Address: BIRCH STEWART KOLASCH & BIRCH, PO BOX 747, FALLS CHURCH, VA, 22040-0747, US

(21) Appl. No.: 10/851,148

(22) Filed: May 24, 2004

(51) Int. Cl. G02F 1/1335

(52) U.S. Cl. 428/212

(57) ABSTRACT

A substrate has a substrate member, which is made of Cyclic Olefins Polymer (COP) or Cyclic Olefins Copolymer (COC), and two protective layers, which are made of Polymethyl methacrylate (PMMA) or Polycarbonate (PC), provided on opposite side of the substrate member. The COP or COC substrate member has a less water absorption (<0.01%) to prevent the substrate from warping while it is irradiated at single side. The PMMA or PC protective layer has a greater hardness to protect the substrate from damage.

### BACKGROUND OF THE INVENTION

1. Field of the Invention

The present invention relates generally to an optical device, and more particularly to a substrate, which is capable of preventing the substrate from warping and has the protective layers to prevent it from scrubbing.

2. Description of the Related Art

A conventional optical substrate is made of Polymethyl methacrylate (PMMA) or Polycarbonate (PC) that the materials have a greater water absorption. In a standard test of ASTM D570, the water absorption of PMMA is 0.3% and the water absorption of PC is 0.2%.

A conventional backlight unit 50 is shown in FIG. 3 to FIG. 5. The backlight unit 50 is consisted of a frame 52 on which a plurality of lamps 54 and a diffuser 56 are mounted. The diffuser 56 has a first side 561, which is a side oriented to the lamps 54, and a second side 562, which is a side opposite to the first side 561, and the water permeated in the diffuser 56 are shown as dots in FIG. 3. As shown in FIG. 4, while the lamps 54 are turned on, the first side 561 of the diffuser 56 is exposed in the light of the lamps 54 directly and the permeable water in the diffuser 56 at where adjacent to the first side 561 is evaporated to escape from the diffuser 56 via the first side 681. In such condition, the diffuser 56 has a greater water vapor at where adjacent to the second side 562 and a less water vapor at where adjacent to the first side 561. In other words, the diffuser 56 has various material properties at the first side 561 and at the second side 562. In additional, the lamps 54 irradiate the first side 561 of the diffuser 56 directly that makes the temperature at the first side 561 is greater than the temperature at the second side 562. Both factors of the material property and the temperature variety at the first side 561 and the second side 562 of the diffuser 56 make the diffuser 56 warping as shown in FIG. 5.

An earlier invention of the present inventors disclosed an optical substrate, which is made of PMMA or PC, is provided with insulating layers on opposite sides thereof. The insulating layers are made of Cyclic Olefins Polymer (COP) or Cyclic Olefins Copolymer (COC), which has a water absorption less than 0.01%. The insulating layers block the water in the substrate vaporized out to fix the problem as described above. The COP layers and the COC layers have a less hardness (about HB to H) and easy to be attacked by oil. While such optical substrate with the COP or COC insulating layer is applied to a product and the substrate is exposed in air and/or touchable by people, the substrate is scratched or attached by oil.

### SUMMARY OF THE INVENTION

The primary objective of the present invention is to provide a substrate, which will not warp while the substrate is heated on a single side thereof.

The secondary objective of the present invention is to provide a substrate, which the substrate is not easy to be scratched or attacked by oil.

According to the objectives of the present invention, a substrate having a substrate member and protective layers provided on both sides of the substrate member, wherein the substrate member is made of Cyclic Olefins Polymer (COP) and the protective layers are made of a material with a hardness greater than the substrate member.

### BRIEF DESCRIPTION OF THE DRAWINGS

FIG. 1 is a sectional view of a preferred embodiment of the present invention;

FIG. 2 is a sectional view of the backlight unit in which the substrate of the preferred embodiment of the present invention serves as the diffuser plate;

FIG. 3 is a sectional view of the diffuser of the direct-light backlight unit and the lamps, wherein the lamps are off;

FIG. 4 follows FIG. 3, showing the lamps being turned on to evaporate water in the diffuser, and

FIG. 5 follows FIG. 4, showing the diffuser warped because the temperature variety on both sides thereof.

### DETAILED DESCRIPTION OF THE INVENTION

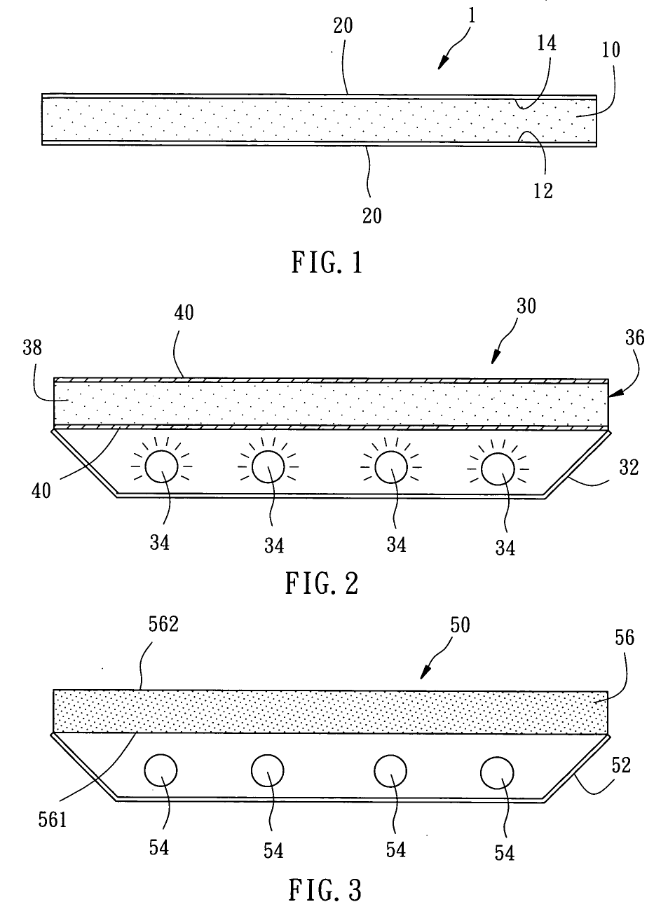

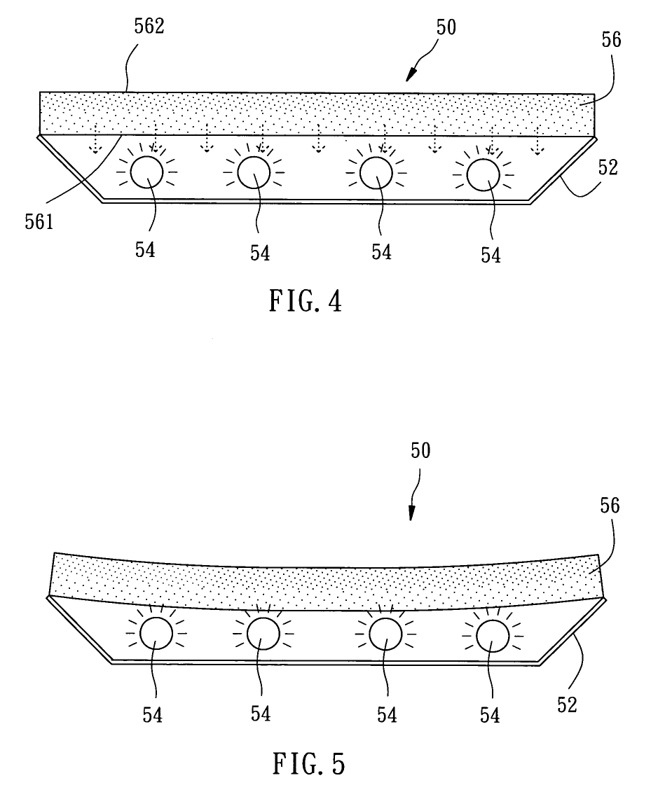

As shown in FIG. 1, the first preferred embodiment of the present invention provides a substrate 1 comprises a substrate member 10 having a first side 12 and a second side 14 and two protective layers 20 provided on the first and the second sides 12 and 14 of the substrate member 10 respectively.

The substrate member 10 is made of Cyclic Olefins Polymer (COP) or Cyclic Olefins Copolymer (COC). This thermoplastic have several special properties including clear and colorless, absorb almost no moisture and highly impermeable to water, low shrinkage, low birefringence, high thermal resistance, good dimension stability, low dielectric constant and excellent resistance to aqueous acids, bases or polar organics. The water absorption is less than 0.01%, in a standard test of ASTM D570, for both COP and COC. The COP or COC substrate member 10 has very less water absorbed therein and that would make the substrate member 10 not warped when the substrate member 10 is irradiated at single side.

The protective layers 20 are made of Polymethyl methacrylate (PMMA) or Polycarbonate (PC). PMMA has a hardness about 2H to 3H and PC has a hardness about 1H to 2H, in other words, the protective layers 20 is harder than the substrate member 10. PMMA and PC also have a well resistant to oil. The protective layers 20 serve as a shield to make the substrate member 10 not exposed. The protective layers 20 protect the substrate 1 from being scratched or attacked by oil.

The methods of how to provide the protective layers 20 on the substrate member 10 have co-extrusion method, coating method and evaporation method etc. The coating method has dip coating, slit coating and spin coating. The evaporation method has chemical vapor deposition (CVD) and physical vapor deposition (PVD).

It is noted that the water absorption of PMMA or PC protective layers 20 (0.3% for PMMA and 0.2% for PC) is greater than the water absorption of COP or COC substrate member 10 (<0.01% for both COP and COC). While a ratio of a thickness of the protective layer 20 and a thickness of the substrate member 10 is designated as less than ⅕, the substrate 1 is not warped under the condition of irradiated at single side thereof. In the present preferred embodiment, the thickness of the substrate member 10 is preferred greater than 0.5 mm and the thickness of the protective layers 20 is preferred greater than 1 μm. More preferable, the thickness of the substrate member 10 is in a range of between 1 mm and 5 mm and the thickness of the protective layers 20 is in a range of between 50 μm and 500 μm.

FIG. 2 shows the substrate 1 of the present invention is applied to a backlight unit 30. The backlight unit 30 has a frame 32 on which a plurality of lamps 34 and a diffuser plate 36 are mounted. The diffuser plate 36 is made of the substrate of the present invention having a COP substrate member 38 and two PC protective layers 40. The substrate member 38 has very less water absorbed therein, so that the diffuser plate 36 is not warped while the lamps 34 are turned on.

The substrate of the present invention can be applied to the diffuser plate of the direct-light backlight unit, the light guild plate of the edge-light backlight unit, the protective plate of the window, the optical lens, screen and other suitable products.

1. A substrate, comprising a substrate member having a first side and a second side and on the first side and the second side of the substrate member provided with a protective layer respectively, wherein the substrate member is made of Cyclic Olefins Polymer and the protective layer is made of a material having a hardness greater than the substrate.

2. The substrate as defined in claim 1, wherein the substrate member is preferable made of Cyclic Olefins Copolymer.

3. The substrate as defined in claim 1, wherein the protective layer is made of Polymethyl methacrylate.

4. The substrate as defined in claim 1, wherein the protective layer is made of Polycarbonate.

5. The substrate as defined in claim 1, wherein a method of providing the protective layers on the substrate member is chosen from a co-extrusion method, a coating method and an evaporation method.

6. The substrate as defined in claim 1, wherein the protective layer has a thickness greater than 1 μm.

7. The substrate as defined in claim 1, wherein the protective layer has a thickness greater than 1 μm and the substrate member has a thickness greater than 0.5 mm.

8. The substrate as defined in claim 1, wherein the protective layer has a thickness in a range of between 50 μm and 500 μm and the substrate member has a thickness in a range of between 1 mm and 5 mm.

9. The substrate as defined in claim 1, wherein the protective layer has a thickness and the substrate member has a thickness and a ratio of the thickness of the protective layer and the thickness of the substrate member is less than ⅕.

10. The substrate as defined in claim 1, wherein the hardness of the protective layer is greater than 1H.
